(19) United States
(12) Patent Application Publication
(10) Pub. No.: US 2025/0385462 A1
(43) Pub. Date: Dec. 18, 2025

(54) ELECTRICAL CONNECTOR ASSEMBLY WITH AN IMPROVED MATING INTERFACE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: DE-JIN CHEN, Shenzhen (CN); Gao Xiang, Shenzhen (CN); Feng Pan, Austin, TX (US)

(21) Appl. No.: 18/782,549

(22) Filed: Jul. 24, 2024

Related U.S. Application Data
(63) Continuation-in-part of application No. 18/743,438, filed on Jun. 14, 2024.

(51) Int. Cl. H01R 13/518; H01R 13/629

(52) U.S. Cl. CPC H01R 13/518; H01R 13/629

(57) ABSTRACT

A receptacle electrical connector includes: an insulating housing having two first mating slots arranged parallel in a first direction, two second mating slots and one third mating slot, each of the two first mating slots extending in a second direction perpendicular to the first direction; and plural terminals retained in the insulating housing and comprising contacting portions extending into said mating slots, respectively, wherein the two second mating slots are aligned with each other in the first direction, each of the second mating slots is aligned with a corresponding first mating slot in the second direction, and the third mating slot is located at one side of the two second mating slots.

### CROSS REFERENCE TO RELATED APPLICATIONS

This application is a continuation-in-part of U.S. patent application Ser. No. 18/743,438, filed on Jun. 14, 2024.

### BACKGROUND OF THE INVENTION

### Field of the Invention

The present invention relates to an electrical connector assembly including a plug connector and a receptacle connector with an improved mating interface.

### Description of Related Arts

China Utility Patent No. CN217903515U discloses a receptacle connector mounted on a PCB and a plug connector connecting with cables. The receptacle connector includes three signal ports loaded with signal terminals and one power port loaded with two power terminals. The power port is higher than the signal port in the mating direction, and larger than the signal portion in the transverse direction perpendicular to the side wall of the insulating housing. The power port may not meet a trend of high density, high signal speed, and small form factor in server applications. An improved electrical connector assembly is desired.

### SUMMARY OF THE INVENTION

The instant invention is to provide an electrical connector assembly with an improved mating interface.

To achieve the above-mentioned object, a receptacle electrical connector comprises: an insulating housing having two first mating slots arranged parallel in a first direction, two second mating slots and one third mating slot, each of the two first mating slots extending in a second direction perpendicular to the first direction; and a plurality of terminals retained in the insulating housing and comprising contacting portions extending into said mating slots, respectively, wherein the two second mating slots are aligned with each other in the first direction, each of the second mating slots is aligned with a corresponding first mating slot in the second direction, and the third mating slot is located at one side of the two second mating slots.

To achieve the above-mentioned object, a plug electrical connector comprises: an insulating housing having a base portion; two first paddle cards extending across the base portion and arranged parallel to each other in a first direction, each of the two paddle cards extending in a second direction perpendicular to the first direction; two second paddle cards extending across the base portion and aligned with the first paddle cards in the second direction, respectively; and one third paddle card extending across the base portion, wherein the third paddle card is located at one side of the two second paddle cards and extends to the first paddle card in the first direction.

To achieve the above-mentioned object, a receptacle connector comprises: an insulating housing having a longitudinal first mating slot extending in a longitudinal direction; two rows of signal terminals comprising contacting portions located at opposite sides of the first mating slot and connecting portions; two rows of cables connected with the connecting portions of the signal terminals; and two covers sandwiching the two rows of cables in a height direction perpendicular to the longitudinal direction, wherein the two covers have a same construct, the cover comprises a main board, two hook portions extending perpendicular from an end of the main board, a positioning board extending from another end of the main board in the longitudinal direction, and two holes located near the positioning board and extending through the main board in the height direction, and wherein one of the two covers is reversely assembled to another of the two covers and the hook portions are inserted into and locked with complementary holes of the two covers.

### BRIEF DESCRIPTION OF DRAWINGS

FIG. 1 is a front perspective view of a receptacle connector in accordance with the present invention;

FIG. 2 is a bottom perspective view of the receptacle connector in FIG. 1;

FIG. 3 is a front elevational view of the receptacle connector in FIG. 1;

FIG. 4 is a front perspective view of an insulating housing of the receptacle connector in FIG. 1;

FIG. 5 is a front perspective view of signal terminal modules, power terminals in FIG. 1;

FIG. 6 is a rear exploded perspective view of the receptacle connector without a metallic shell in FIG. 1;

FIG. 7 is a front perspective view of two covers disconnecting from each other;

FIG. 8 is a rear perspective view of two covers in FIG. 7;

FIG. 9 is a front perspective view of two covers assembled together in FIG. 7;

FIG. 10 is a rear perspective view of two covers in FIG. 9;

FIG. 11 is a front elevational view of four covers assembled together;

FIG. 12 is a rear elevational view of four covers in FIG. 11;

FIG. 13 is a sketch elevational view of two middle covers in FIG. 11;

FIG. 14 is a front perspective view of the metallic shell;

FIG. 15 is a front perspective view of a plug connector of this present invention;

FIG. 16 is a rear perspective view of the plug connector in FIG. 15;

FIG. 17 is a front elevational view of the plug connector in FIG. 15; and

FIG. 18 is a side elevational view of the plug connector in FIG. 15.

### DETAILED DESCRIPTION OF THE DRAWINGS

Reference will now be made in detail to the preferred embodiments of the present invention.

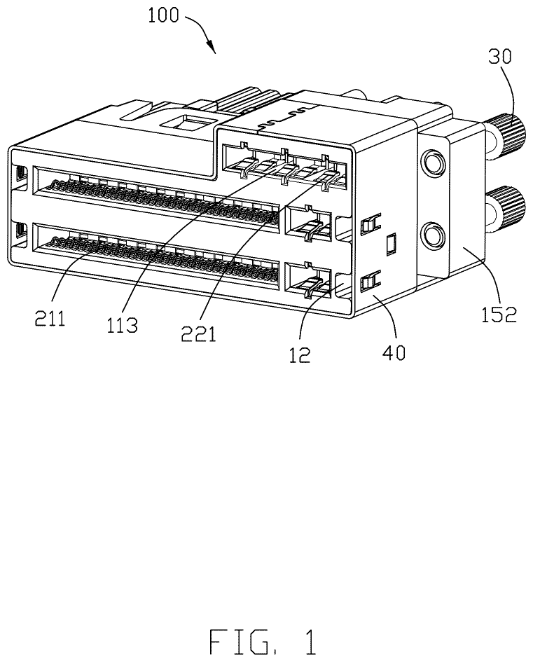

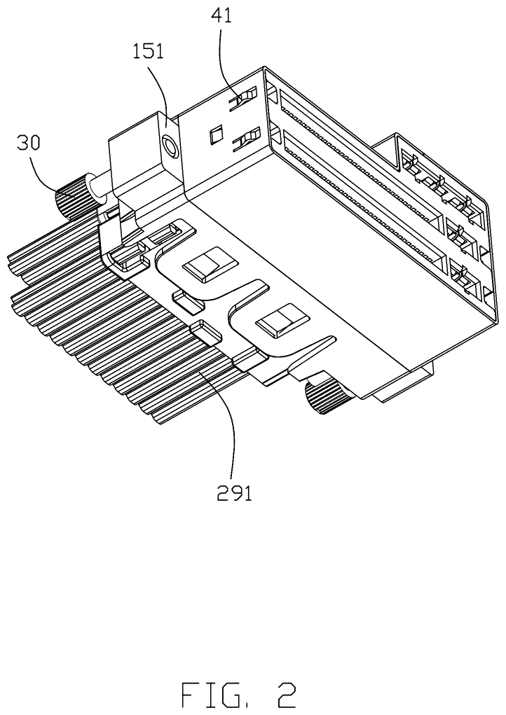

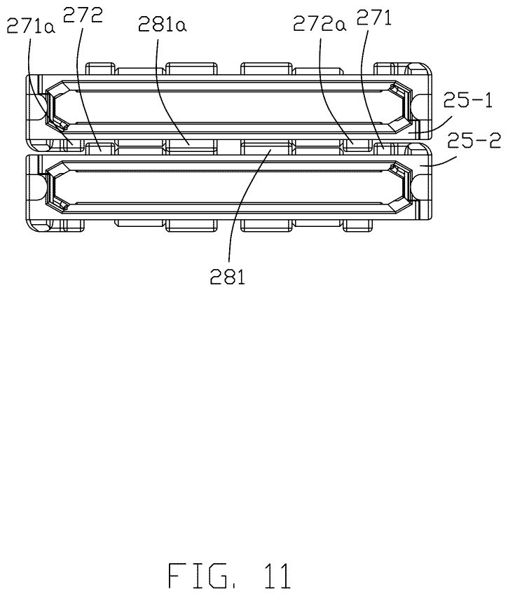

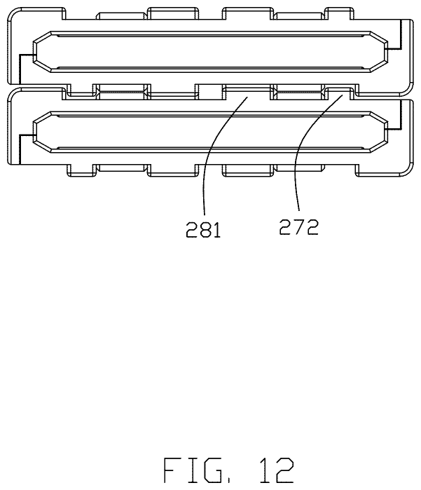

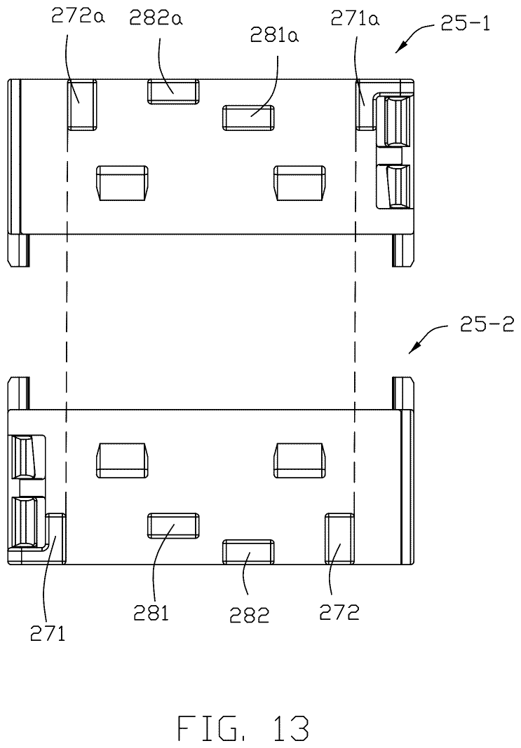

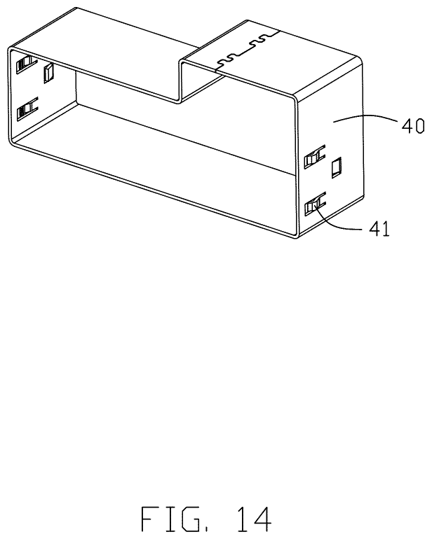

Referring to FIGS. 1-14, an electrical connector assembly of an embodiment of this present invention includes a receptacle connector 100 and a plug connector 200, which two connectors are adapted for mating with each other. The two electrical connectors are connected with cables 291, 292 at rear ends thereof, respectively.

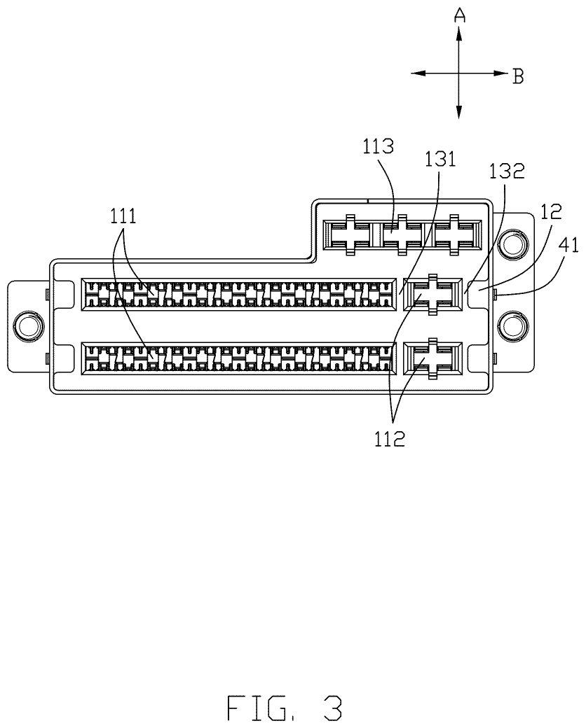

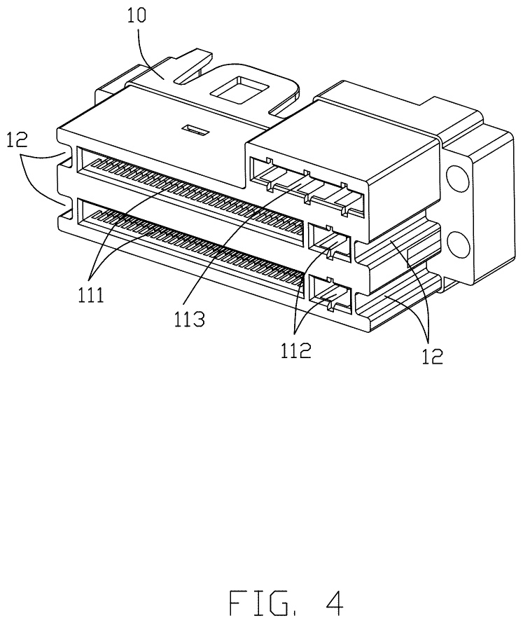

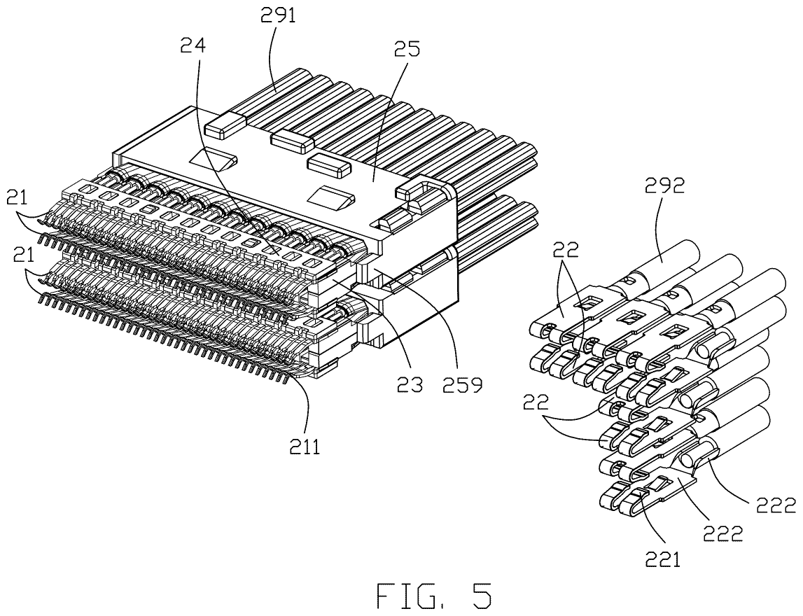

Referring to FIGS. 4-5, the receptacle connector 100 includes an insulating housing 10 having five longitudinal mating slots opening forwards and a plurality of conductive terminals with contacting portions extending in the mating slots respectively. Combination with FIG. 3, in this embodiment, the insulating housing 10 has two first mating slots 111 arranged parallel in a first direction A or a height direction, two second mating slots 112 and one third mating slot 113. Each of the first mating slots 111 is longitudinal and extends in a second direction B or a longitudinal direction perpendicular to the first direction. The second mating slot 112 is aligned with corresponding first mating slot 111 in the second direction, the two second mating slots 112 are aligned with each other in the first direction. The third mating slot 113 is located at one side of the two second mating slots 112. The third mating slot 113 is longer than the second mating slot 112 in the second direction, and span beyond opposite longitudinal ends of the second mating slot 112 and extend to the first mating slot 111 in the second direction as clearly shown in FIG. 3.

In this embodiment, each first mating slot 111 is disposed with two rows of signal terminals 21 at opposite sides thereof, the second mating slot 112 is disposed with two power terminals 22 at opposite sides thereof. The third mating slots 113 is disposed with two rows of the power terminals 23 at opposite sides thereof, each row of the power terminals is composed of three power terminals. It is noted that the signal terminals 21 may include pairs of terminals transmitting differential signal and grounding terminals between the pairs of signal transmitting terminals for shielding and grounding function, and other terminals transmitting lower signals. The power terminals 22 are for transmitting larger powers. The power terminals 22 and the signal terminals 21 are connected with coaxial cables 291, 292 respectively. Each of the power terminals 22 includes a retaining portion 222, two contacting arms 221 extending forwards from the retaining portion 222 and a cable-connecting portion 223 to crimp the conductive core of power cable 292, the contacting arms 221 extending forwards firstly and then folds inwards to form contacting portions exposing upon the second mating slot 112 and the third mating slot 113.

The row of the signal terminal 21 is embedded in an insulator 23, a metallic grounder (not shown) is located in the insulator 23 and a conductive plastic 24 is assembled or injected and retained at an outer side of the insulator 23 so as to form a terminal module. The contacting portions 211 of the signal terminals extend out of the insulator 23 and extend into the first mating slots 111. A row of signal cables 291 are connected with the signal terminals 21. Two terminals modules are assembled together and two covers 25 used to sandwich the two rows of signal cables 291. The four terminal modules are assembled together and then inserted forward to the insulating housing 10 and the contacting portions 211 of the four terminal modules are exposed upon the two first mating slot 111.

Referring to FIGS. 1-4, the insulating housing 10 has two guiding holes 12 at opposite ends of the first and second mating slots 111, 112 in the second direction, the guiding holes 12 are aligned with corresponding first mating slot 111 in the second direction, and no guiding holes are disposed at opposite ends of the third mating slot 113. A metallic shell 40 surrounds around an outer side of the insulating housing 10 for shielding performance. Further, each of the guiding holes 12 is defined by the metallic shell 40 at an outer side perpendicular to the second direction. The metallic shell 40 has four spring finger 41 extending forward therefrom, each spring finger 41 has a touching portion protruding outward away from the mating slots in the second direction, each of the four spring finger 41 is aligned with corresponding guiding hole 12. The first mating slot 111, the second mating slots 112 and the guiding holes 12 are separated by partitioning walls 131, 132. The guiding holes 20 are of a square shape viewed in a mating direction or a front-rear direction as shown in FIG. 3.

Referring to FIGS. 1, 3, and 6, the insulating housing 10 further has two mounting flanges 151, 152 at opposite ends thereof in the second direction, screw bolts 30 are retained in the holes 1511 defined on the mounting flange 151, 152. The two mounting flanges 151 are located behind the metallic shell 40 and at outsides of the metallic shell. The first mounting flange 151 is located near the first mating slot 111 with a smaller width, so that the first mounting flange 151 is loaded with one screw bolt 30, the second mounting flange 152 is near the second and third mating slots 112, 113, so that the second mounting flange 152 is loaded with two screw bolts 30 in the first direction.

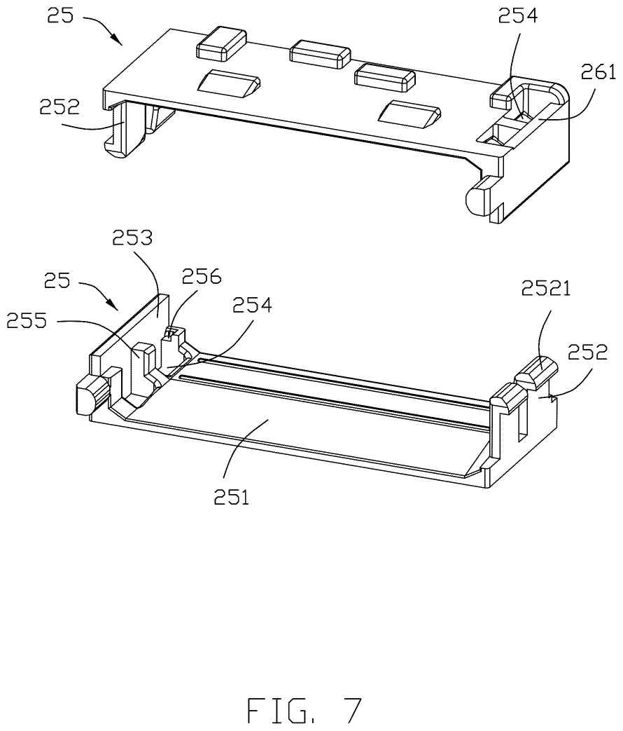

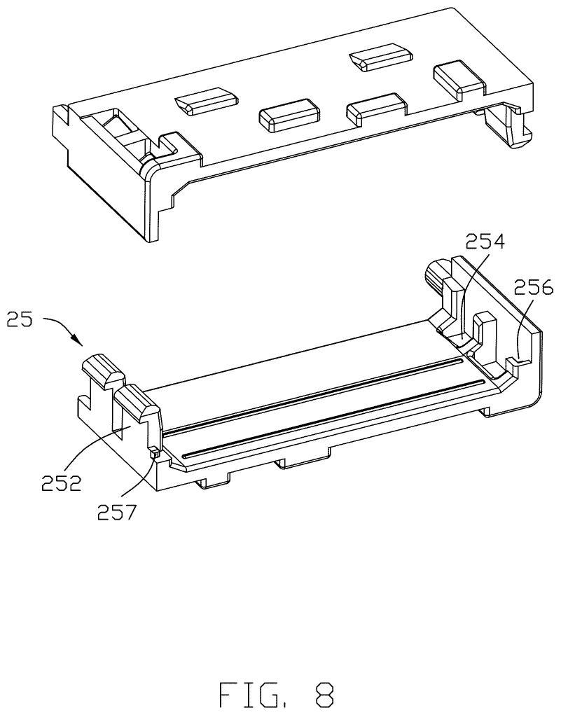

Referring to FIGS. 7-8 illustrating two covers, the four covers 25 have a same construct, the upper cover of the two covers rotates 180 degree and is assembled to and retained to the lower cover. The cover 25 includes a main board 251 extending in the front-rear direction and the second direction, two hook portions 252 extending perpendicular from a longitudinal end of the main board in the second direction and a positioning board 253 from another longitudinal end of the main board 251, two holes 254 is located near the positioning board 253 and runs through the main board 251 in the first direction. The two hook portions 252 are arranged in the front-rear direction. Two holes 254 are defined near a root of one longitudinal end of the main board 251 in the second direction. After assembled, the hook portions 252 are inserted and retained in the holes 254, free hooks 2521 of the hook portions fitly press against a top face 261 of the main board 251. Please notes, three upright ribs 255 are disposed between the holes 254 in the front-rear direction. A positioning dent 256 is disposed at a rear upright rib 255, a positioning nub 257 is located at a root of the rear hook portions 252

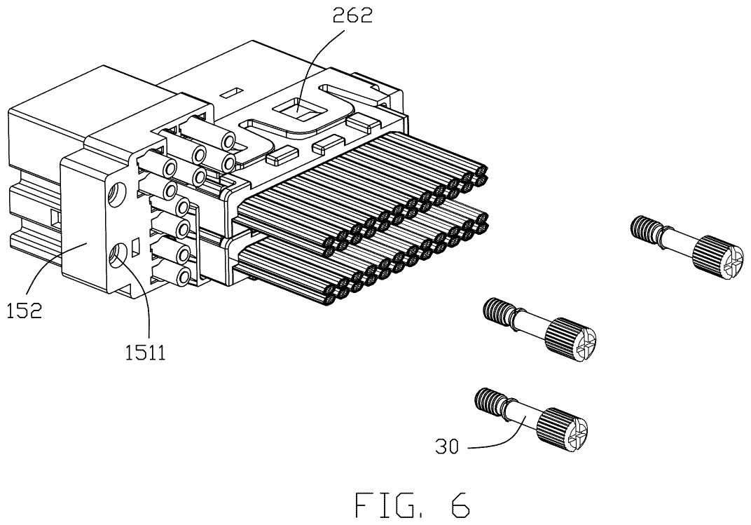

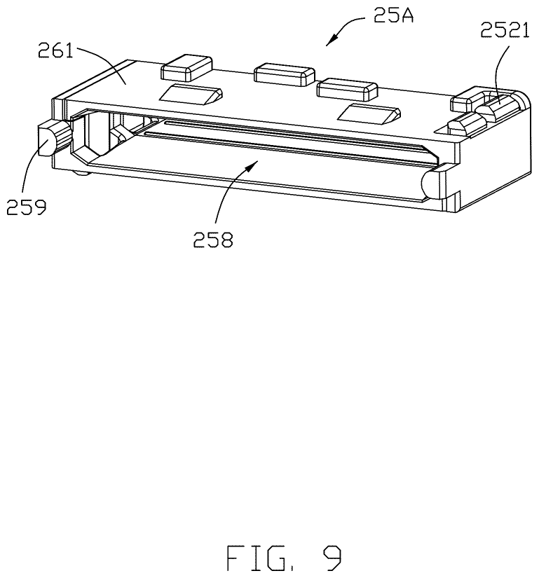

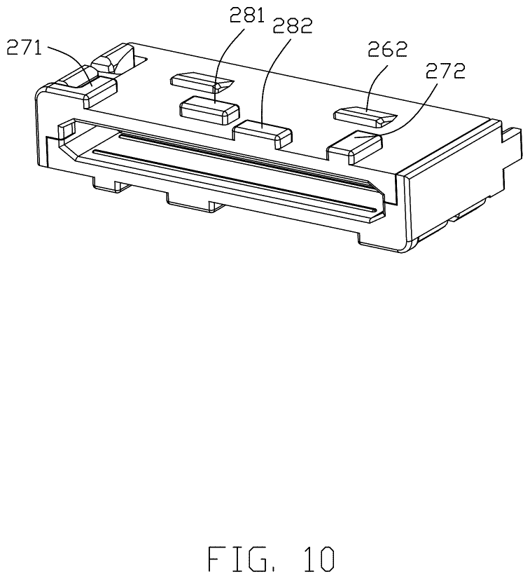

When the two covers 25 are assembled together in the height direction, the hook portions 252 are inserted into and locked with the holes 254 so that the two covers are limited and retained in the front-rear direction, the positioning nub 257 is inserted into the positioning den 256 to limit and retain two covers in the second direction. As shown in FIGS. 9-10, two covers are assembled together as a cover assembly 25A to define a cable-receiving channel 258. Moreover, two cover assemblies 25A are stacked in the first direction, the shape of a top face 261 of the cover is defined to match with each other. Two locking bosses 262 are defined at the top face 261 of the cover, which are located near to a front of the cover. Combination with FIG. 6, the locking bosses 262 are latched with holes defined on the insulating housing 10. A pressing rib 259 extends forwards from a front face of the cover, the pressing ribs 259 press against a rear end of the insulator 23 in combination with FIG. 5.

Referring to FIGS. 10-12, two first limiting ribs 271, 272 and two second limiting ribs 281, 282 protrude from the top face 261. The upper two covers are assembled to retain the upper two rows of signal cables 291, the lower two covers are assembled to retain the lower two rows of signal cables. The engagement of the first limiting ribs 271, 272 and two second limiting ribs 281, 282 of the two middle covers 25-1, 25-2 limits the movement of the upper cable assembly and the lower cable assembly. For distinguish, the elements on the upper middle cover 25-1 is added with a letter a, like 271a, 272a, 281a, 282a. The first limiting ribs 271, 271a, 272, 272a limit the two middle covers shift in the second direction. The two second limiting ribs 281, 281a, 282, 282a limit the movement of the two middle covers in the second direction and the front-rear direction. After assembled, one ribs 281a is located just in front of the rib 282, one ribs 281 is located just in front of the rib 282a.

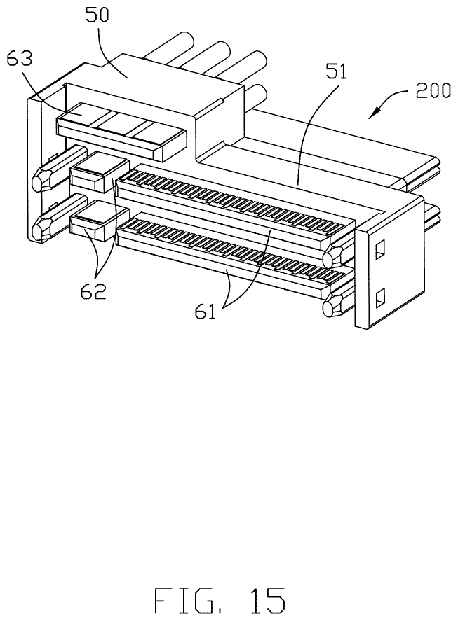

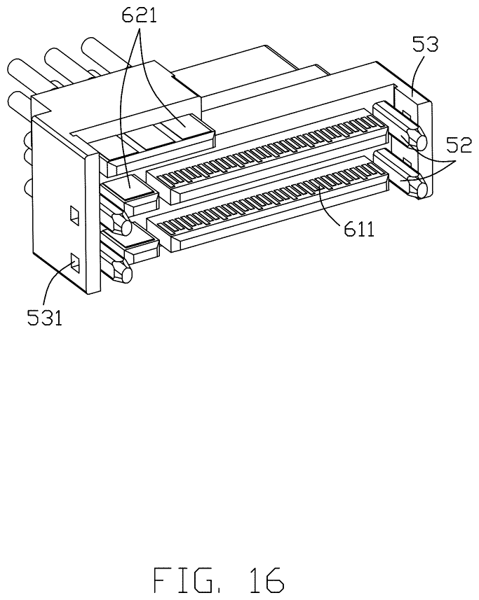

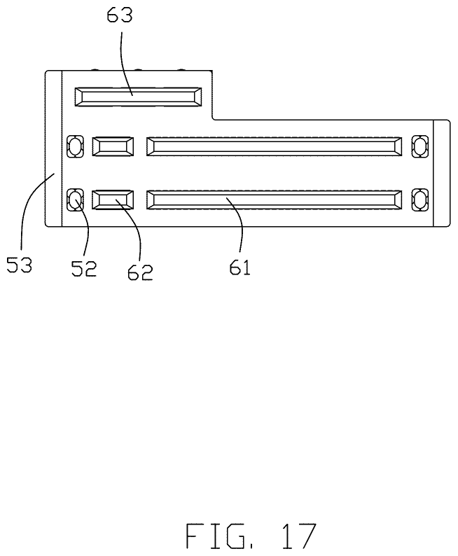

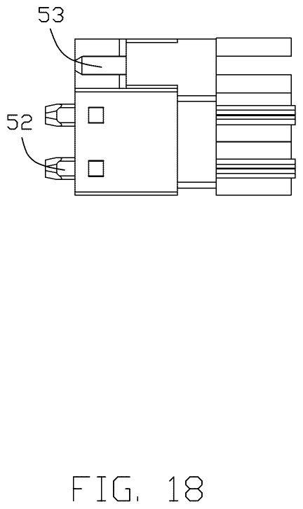

Referring to FIGS. 15-18, the plug connector 200 includes an insulating housing 50 having a base portion 51, and five paddle cards going across the base portion 51. The paddle cards includes two first paddle cards 61 going across the base portion 51 and arranged parallel in the first direction, and two second paddle cards 62 and a third paddle cards 63. Each of the two first paddle cards 61 extends in the second direction perpendicular to the firs direction. The two second paddle cards 62 go across the base portion 51 and aligned with the first paddle cards 61 in the second direction, respectively. The third paddle card 63 goes across the base portion 51 and is located at one side of the two second paddle cards 62, and extend to the first paddle card 61 in the first direction. The first paddle card 61 is loaded with signal pads 611, the second paddle card 62 is located with two power pads 621 at opposite sides thereof, the third paddle card 63 is also located with six power pads 621 at opposite sides thereof.

A pair of guiding posts 52 extends from the base portion 51 and located at opposite ends of each of the first and second paddle cards 61, 62 in the second direction. A pair of guiding boards 53 extends forwards from the base portion 51 beyond the guiding posts 52 in the first direction. The guiding posts 52 extend forwards beyond the paddle cards in the mating direction. Each of the two paddle cards and corresponding guiding posts 52 and corresponding guiding boards 53 aligned with each other in the second direction. The guiding posts 52 protrude forwards beyond the guiding board 53 and the paddle cards for a preliminary position during an engagement of the two connectors. The guiding posts 52 are guided and inserted into the guiding holes 12, the spring fingers 41 are engaged with the holes 531 defined on the positioning boards 53 for a further retaining engagement of the two connectors. The positioning boards 53 are flushed with the base portion 51. Moreover, a metallic plate can alternatively attached to an inside face of the positioning board 53.

Although the present invention has been described with reference to particular embodiments, it is not to be construed as being limited thereto. Various alterations and modifications can be made to the embodiments without in any way departing from the scope or spirit of the present invention as defined in the appended claims.

1. A receptacle electrical connector comprising:
an insulating housing having two first mating slots arranged parallel in a first direction, two second mating slots and one third mating slot, each of the two first mating slots extending in a second direction perpendicular to the first direction; and
a plurality of terminals retained in the insulating housing and comprising contacting portions extending into said mating slots, respectively;
wherein the two second mating slots are aligned with each other in the first direction, each of the second mating slots is aligned with a corresponding first mating slot in the second direction, and the third mating slot is located at one side of the two second mating slots.

2. The receptacle electrical connector as claimed in claim 1, wherein the third mating slots span beyond opposite ends of the second mating slot and extend to the first mating slot in the second direction.

3. The receptacle electrical connector as claimed in claim 2, wherein the first mating slot is disposed with two rows of the signal terminals at opposite sides thereof in the first direction, the second mating slot is disposed with two power terminals at opposite sides thereof in the first direction, and the third mating slots is disposed with two rows of the power terminals at opposite sides thereof in the first direction.

4. The receptacle electrical connector as claimed in claim 3, wherein the row of the power terminals is composed of three power terminals.

5. The receptacle electrical connector as claimed in claim 1, wherein the insulating housing has two guiding holes at opposite ends of the first and second mating slots in the second direction, the two guiding holes are aligned with a corresponding first mating slot in the second direction, and no guiding hole is disposed at opposite ends of the third mating slot.

6. The receptacle electrical connector as claimed in claim 5, further comprising a metallic shell, and wherein the metallic shell surrounds around an outer side of the insulating housing, and each of the guiding holes is defined by the metallic shell at an outer side thereof perpendicular to the second direction.

7. The receptacle electrical connector as claimed in claim 6, wherein the metallic shell has four spring fingers extending forward and each spring finger has a touching portion protruding outward in the second direction, and each of the four spring fingers is aligned with a corresponding guiding hole.

8. A plug connector comprising:
an insulating housing having a base portion;
two first paddle cards extending across the base portion and arranged parallel to each other in a first direction, each of the two paddle cards extending in a second direction perpendicular to the first direction;
two second paddle cards extending across the base portion and aligned with the first paddle cards in the second direction, respectively; and
one third paddle card extending across the base portion;
wherein the third paddle card is located at one side of the two second paddle cards and extends to the first paddle card in the first direction.

9. The plug connector as claimed in claim 8, wherein a pair of guiding posts extends forwards from the base portion and is located at opposite ends of the first and second paddle cards in the first direction.

10. The plug connector as claimed in claim 8, wherein the first paddle card is loaded with signal pads, the second paddle card is loaded with two power pads at opposite sides thereof, and the third paddle card is loaded with six power pads at opposite sides thereof.

11. The plug connector as claimed in claim 8, wherein a pair of guiding posts extend forwards from the base portion and are located at opposite ends of each of the first and second paddle cards.

12. The plug connector as claimed in claim 11, wherein a pair of guiding boards extend forwards from the base portion, and the guiding boards extend beyond the guiding posts in the first direction and are separated from two adjacent guiding posts in the second direction.

13. A receptacle connector comprising:
an insulating housing having a longitudinal first mating slot extending in a longitudinal direction;
two rows of signal terminals comprising contacting portions located at opposite sides of the first mating slot and connecting portions;
two rows of cables connected with the connecting portions of the signal terminals; and
two covers sandwiching the two rows of cables in a height direction perpendicular to the longitudinal direction;
wherein the two covers have a same construct, the cover comprises a main board, two hook portions extending perpendicular from an end of the main board, a positioning board extending from another end of the main board in the longitudinal direction, and two holes located near the positioning board and extending through the main board in the height direction;
wherein one of the two covers is reversely assembled to another of the two covers and the hook portions are inserted into and locked with complementary holes of the two covers.

14. The receptacle connector as claimed in claim 13, wherein the cover has two first limiting ribs and two second limiting ribs defined on a top face thereof, and the two first limiting ribs limit a movement of two covers when top faces of the two covers are disposed adjacent to each other.
